(19) United States
(12) Patent Application Publication
(10) Pub. No.: US 2012/0216618 A1
(43) Pub. Date: Aug. 30, 2012

(54) METHODS AND SYSTEMS FOR IMAGING INTERNAL RAIL FLAWS

(76) Inventors: Jeffrey A. Bloom, Silver Spring, MD (US); Amaury Rolin, Washington, DC (US); Stanley Radzevicius, Fairfax, VA (US); David McNew, Glen Berni, MD (US); Gary A. Carr, Fairfax, VA (US)

(21) Appl. No.: 13/406,752

(22) Filed: Feb. 28, 2012

Related U.S. Application Data
(60) Provisional application No. 61/447,642, filed on Feb. 28, 2011.

(51) Int. Cl. G01N 29/04

(52) U.S. Cl. 73/636

(57) ABSTRACT

A method for imaging internal flaws of a rail is disclosed. The method may include transmitting multiple ultrasound pulses into the rail along transverse and longitudinal axes of the rail, acquiring reflected ultrasound data from the rail, processing the reflected ultrasound data by applying an ultrasound migration technique to the reflected ultrasound data, and mapping the internal flaws of the rail based on the reflected ultrasound data processed by the ultrasound migration technique.

### CROSS-REFERENCE TO RELATED APPLICATION

This application claims the benefit of priority under 35 U.S.C. §119 to U.S. Provisional Patent Application No. 61/447,642, filed Feb. 28, 2011, which is incorporated herein by reference in its entirety.

### GOVERNMENT RIGHTS

This invention was made with Government support under Contract No. DTFR53-05-D-00205, Task Order 30, awarded by the Federal Railroad Administration. The government may have certain rights in this invention.

### FIELD OF THE DISCLOSURE

Embodiments of the present disclosure include methods and systems for imaging internal rail flaws, and more particularly, imaging internal rail flaws by processing ultrasound reflection data by a migration technique.

### BACKGROUND OF THE DISCLOSURE

Maintaining proper conditions of rail components of a railroad track is of paramount importance in the railroad transportation industry. Rails of the railroad track may be subject to movement, wear, and defects due to the passage of trains over the rails. Internal flaws and defects, such as fractures, cracks, and other abnormalities, may be created in the rails by, for example, the passage of heavy rolling stock over the rails. Generally, an ultrasonic rail inspection system may be mounted on a rail vehicle, and as the vehicle rolls on top of the rail, the ultrasonic rail inspection system may inspect the rail for such internal flaws. More particularly, the ultrasonic rail inspection system may include ultrasound probes contacting the rail that may send ultrasonic pulses into the rail. Reflection energy from the rail may then be identified to locate potential internal rail defects. Once a potential internal rail defect is identified by the inspection vehicle, an inspector may further test the suspected area manually with a handheld ultrasonic probe to confirm the presence of the internal rail flaw.

The inspector may test the suspected area by sending ultrasonic pulses at various angles and locations. Internal defects or discontinuities of the rail may reflect the ultrasound pulse back, and the probe may identify the reflected energy as a function of time and amplitude, e.g., as an A-Scan.

The handheld ultrasound probe, however, does not directly image an identified internal rail defect, nor give a direct identification of the size, orientation, and depth of the defect. Typically, the inspector must rely on his or her judgment and expertise to interpret ultrasound data to identify the location and nature of a defect. Therefore, there is a need for improved data gathering relating to rail defects.

### SUMMARY OF THE DISCLOSURE

In accordance with an embodiment, a method for imaging internal flaws of a rail may include transmitting multiple ultrasound pulses into the rail along transverse and longitudinal axes of the rail, acquiring reflected ultrasound data from the rail, processing the reflected ultrasound data by applying an ultrasound migration technique to the reflected ultrasound data, and mapping the internal flaws of the rail based on the reflected ultrasound data processed by the ultrasound migration technique.

In accordance with another embodiment, a method for imaging internal flaws of a rail may include transmitting multiple ultrasound pulses into the rail along a plurality of axes of the rail, acquiring reflected ultrasound data from the rail, processing the reflected ultrasound data by applying an ultrasound migration technique to the reflected ultrasound data, compiling cross-sectional images of the internal flaws of the rail along the rail based on the reflected ultrasound data processed by the ultrasound migration technique, and producing a three-dimensional model of the rail based on the compiled cross-sectional images, wherein the internal flaws of the rail are mapped within the three-dimensional model of the rail.

In accordance with another embodiment, a method for imaging an internal flaw of a rail may include transmitting multiple ultrasound pulses into the rail along a plurality of axes of the rail, acquiring reflected ultrasound data from the rail, processing the reflected ultrasound data by applying an ultrasound migration technique to the reflected ultrasound data, determining a size of the internal flaw relative to the rail based on the reflected ultrasound data processed by the ultrasound migration technique, determining a position of the internal flaw relative to the rail based on the reflected ultrasound data processed by the ultrasound migration technique, and classifying the internal flaw under one or more types of rail defects.

In yet another embodiment, a support mechanism for an ultrasonic rail inspection system including a probe and an encoder is disclosed. The support mechanism may include a container for holding an acoustic couplant, the container including a channel for receiving a portion of a rail, a sealing membrane configured to provide a barrier between the rail and the acoustic couplant contained within the container, a track configured to allow the probe to translate along the rail, and a coupling device configured to couple the probe to the encoder.

### BRIEF DESCRIPTION OF THE DRAWINGS

FIG. 1 illustrates a diagrammatic representation of an ultrasonic rail inspection system, according to an exemplary disclosed embodiment;

FIG. 2 illustrates a block diagram for an exemplary process of imaging internal defects of a rail using the ultrasonic rail inspection system of FIG. 1, according to an exemplary disclosed embodiment;

FIG. 3 illustrates an exemplary unmigrated intensity map, according to an exemplary disclosed embodiment;

FIG. 4 illustrates an exemplary migrated intensity map, according to an exemplary disclosed embodiment;

FIG. 5 illustrates an exemplary three-dimensional model of a tested rail based on migrated ultrasound data, according to an exemplary disclosed embodiment;

FIG. 6 illustrates another exemplary unmigrated intensity map, according to an exemplary disclosed embodiment;

FIG. 7 illustrates another exemplary migrated intensity map, according to an exemplary disclosed embodiment;

FIG. 8 illustrates another exemplary three-dimensional model of a tested rail based on migrated ultrasound data, according to an exemplary disclosed embodiment; and

FIG. 9 illustrates a perspective view of an exemplary support mechanism for the ultrasonic rail inspection system of FIG. 1, according to an exemplary disclosed embodiment.

### DETAILED DESCRIPTION

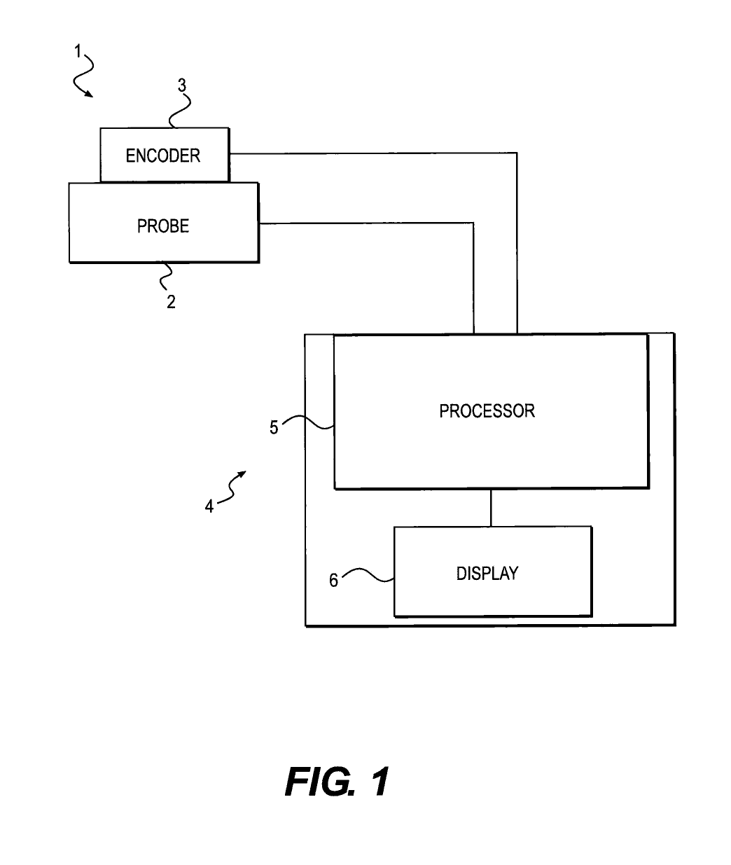

FIG. 1 illustrates a diagrammatic representation of an ultrasonic rail inspection system 1, according to an exemplary embodiment. Inspection system 1 may include a multiple element array probe 2, an encoder 3, and a control system 4. Inspection system 1 may be configured to, for example, test a section of a rail for purposes of identifying and determining certain properties of internal rail flaws and defects. More particularly, inspection system 1 may be configured to produce a three-dimensional image of the internal rail defects and accurately identify, for example, the location, size, depth, and orientation of such defects relative to the rail.

Multiple element array probe 2 may include a one-dimensional multiple element array probe having a plurality of ultrasound transducers. Multiple element array probe 2 may also include, for example, a multiple element phased array probe. In one embodiment, probe 2 may be a one-dimensional, multiple element phased array probe, with a length of the array configured to be transversely oriented across the rail. The elements (i.e., the plurality of ultrasound transducers) may be spaced a predetermined distance from each of other. Moreover, each element may be configured to produce a longitudinal ultrasonic pulse into the rail and detect reflected ultrasound energy. Ultrasound energy may be reflected from, for example, an internal defect or flaw in the rail. Accordingly, longitudinal wave ultrasound data may include the amplitude of reflected energy as a function of time to reflect back to the transducer. The combined reflected ultrasound energy from the plurality of elements may produce a transverse data slice of reflected energy with a spatial sampling determined by the predetermined spacing between each element. Probe 2 may also be configured to acquire reflection data along the length of the rail by moving probe 2 along the rail. It should also be appreciated that probe 2 may be sized to be a handheld device for an operator. Furthermore, because probe 2 may employ multiple array elements, the time to cover the entire testing portion of the rail may be reduced when compared to using a single element ultrasound probe. Moreover, in certain embodiments, probe 2 may be configured to perform an electronic scanning technique, wherein a number of the plurality of ultrasound transducers may form a focused ultrasonic pulse that may be pulsed into the rail.

Encoder 3 may be, for example, a magnetic linear encoder, an optical encoder, or a linear transducer and may be configured to measure a location of probe 2 relative to the rail. For example, as probe 2 travels along the length of the rail, encoder 3 may travel with probe 2 and may determine a position of probe 2 relative to a longitudinal axis of the rail.

Control system 4 may include a processor 5 and a display 6. Processor 5 may be in communication with probe 2 and encoder 3. Processor 5 may be configured to receive location data associated with probe 2 from encoder 3. In addition, processor 5 may be configured to selectively signal probe 2 to acquire longitudinal wave ultrasound data of the rail. For instance, processor 5 may initiate probe 2 to produce an ultrasonic pulse and receive reflected energy at equally spaced, predetermined positions along the rail. Positional data received from encoder 3 may be utilized by processor 5 to determine when to initiate probe 2. Processor 5 may also receive the longitudinal wave ultrasound data from probe 2. The ultrasound data may then be processed by processor 5. For example, software and/or programs associated with processor 5 may process the ultrasound data received from probe 2 and output imaging data pertaining to, for example, a location, size, orientation, and depth of a detected defect in the rail. By way of example, processor 5 may employ programs and algorithms related to, for example, migration or synthetic aperture focusing techniques, to process the ultrasonic data and output imaging data accurately identifying and locating the source of the reflected ultrasound energy (i.e., an internal defect or flaw of the rail).

Processor 5 may be configured to output imaging data to display 6. Display 6 may include any type of device (e.g., CRT monitors, LCD screens, etc.) capable of graphically depicting information. For example, display 6 may depict information related to properties of the detected internal rail defect, such as location, size, orientation, and depth relative to the tested rail.

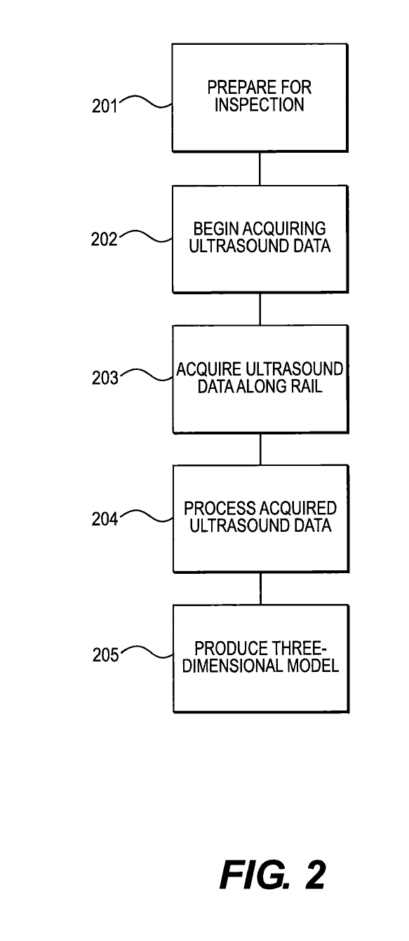

FIG. 2 is a block diagram illustrating a process of imaging internal defects of a rail using ultrasonic rail inspection system 1. Once a suspected flaw area of the rail is identified, the test area of the rail and probe 2 may be prepared for inspection, step 201. For example, an ultrasonic couplant, such as water or glycerin, may be applied between probe 2 and the rail. In addition, probe 2 may be oriented on the rail such that ultrasound data transverse to the longitudinal axis of the rail may be generated. In other words, the row of multiple elements of probe 2 may be positioned across the rail and substantially normal to the longitudinal axis of the rail. At step 202, probe 2 may begin acquiring ultrasound data. Each of the multiple array elements (i.e., transducers) may emit ultrasonic pulses into the rail, and may receive and identify reflected ultrasound energy. The reflected ultrasound energy may be received and recorded by processor 5 in the form of energy amplitude as a function of the time to reflect off of a defect and return to probe 2. At step 203, probe 2 may acquire ultrasound data along the length of the rail. Probe 2 may be translated along the length of the rail, and may obtain ultrasound data at predetermined locations along the rail. Encoder 3 may identify the position of probe 2 and deliver the position data to processor 5. Processor 5 may then signal probe 2 to acquire ultrasound data at equally spaced, predetermined locations along the rail. The distance between each ultrasound data location may be a predetermined location stored in a memory of processor 5. For example, the distance between ultrasound data locations may be between 0.1 and 0.5 millimeters. Accordingly, multiple ultrasound data slices along the rail and normal to the longitudinal axis of the rail may be acquired. The acquired ultrasound data may then be organized and imaged. For example, reflection intensity may be imaged on a suitable chart or table, such as, for example, a color map, and generated on display 6.

At step 204, the acquired ultrasound data may be further processed to image internal rail defects. Processor 5 may manipulate the acquired ultrasound data by implementing a migration or synthetic aperture focusing technique algorithm to the ultrasound data, such as that described in “Practical 3-D Migration and Visualization for Accurate Imaging of Complex Geometries with GPR,” Stanley Radzevicius, Journal of Environmental and Engineering Geophysics, June 2008, Vol. 12, Issue 2, pp. 99-112, which is incorporated herein by reference in its entirety. Migration of ultrasound data is a technique which may accurately identify, locate, and size internal defects of structures based on reflected ultrasound energy. The acquired ultrasound data may identify the amplitude of reflected ultrasound energy as a function of time, however, the direction of the reflected ultrasound energy may not be recognized, as the reflected energy may be shown as impinging from multiple locations. A migration technique may utilize the ultrasound data from each position along the length of the rail and create a synthetic aperture. The synthetic aperture may then be used to compute the actual source location of the reflected energy inside the rail and produce an image of the internal defects causing the ultrasound energy reflection. For example, a modified Kirchhoff migration algorithm may determine the location of a defect by performing diffraction summation of the reflected ultrasound data acquired at multiple positions along the length of the rail.

Migration of the acquired ultrasound data may improve the spatial resolution of the ultrasound data and produce a geometrically accurate cross-sectional image of the internal rail defects. The cross-sectional images may then be displayed on display 6.

Processor 5 may also classify the detected internal flaw under one or more types of rail defects. That is, data pertaining to the internal flaw, such as size, orientation, and position relative to the rail, may be utilized by processor 5 to determine a specific type of rail defect. For example, the internal flaw may be classified as a transverse fracture, a detail fracture, a vertical split head, and the like. The classified defect may then be communicated to the operator via, for example, display 6.

A three-dimensional image of the internal rail defects may then be produced at step 205. Processor 5 may compile the migrated cross-sectional images of the internal rail defects along the rail and generate a three-dimensional model of the tested rail, with representations of the internal defects accurately sized, positioned, and oriented within the volume of the rail model. The three-dimensional model may then be displayed on display 6. Accordingly, the internal rail defects may be easily visualized and identified relative to the internal structure of the rail by an operator, which may obviate the need for conventional ultrasound rail inspection techniques. Processor 5 may also compile three-dimensional volumetric images of the internal flaws of the rail and generate a three-dimensional model of the tested rail, with representations of the internal flaws accurately sized, positioned, and oriented within the volume of the rail model.

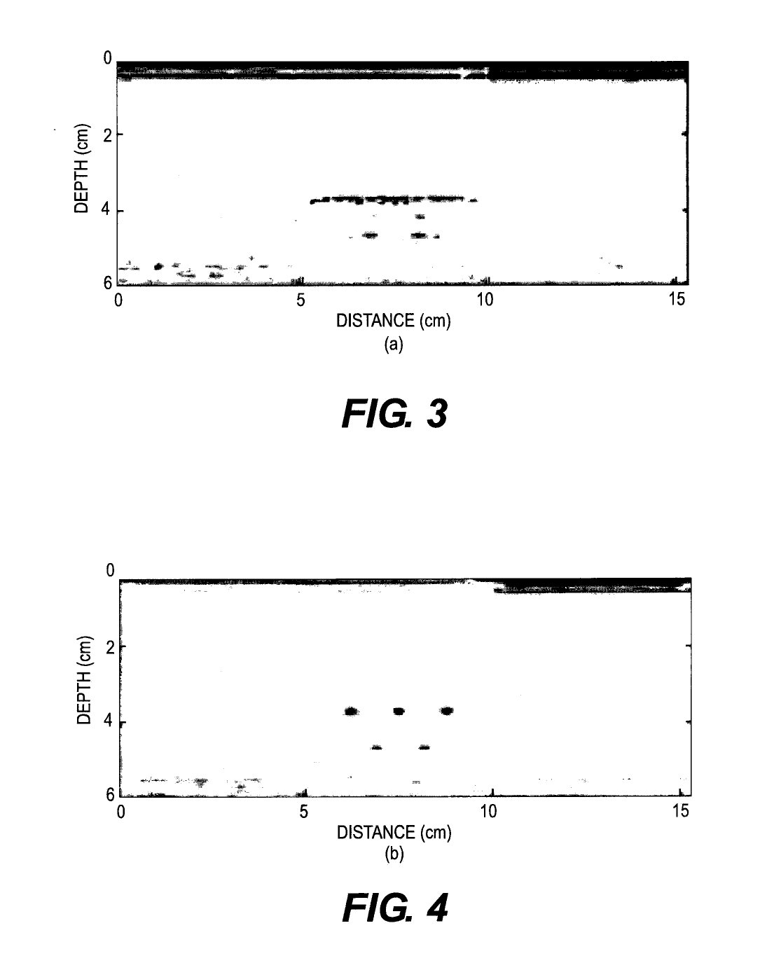

FIG. 3 illustrates an exemplary unmigrated intensity map. The intensity map of FIG. 3 may be, for example, a color map that maps the intensity of backscattered ultrasound energy from three transverse holes internal a tested rail. As shown in FIG. 3, the unmigrated ultrasound data may identify the intensity of reflected energy from the internal rail defects (i.e., the three transverse holes), but the actual location and orientation of the rail defects cannot be accurately identified.

FIG. 4 illustrates an exemplary migrated intensity map. The intensity map of FIG. 4 may be, for example, another color map that maps intensity of backscattered ultrasound energy from the same three transverse holes tested above in FIG. 3. As shown in FIG. 4, migrating the ultrasound data may improve the spatial resolution of the data to accurately produce an image of the location and orientation of the three transverse holes.

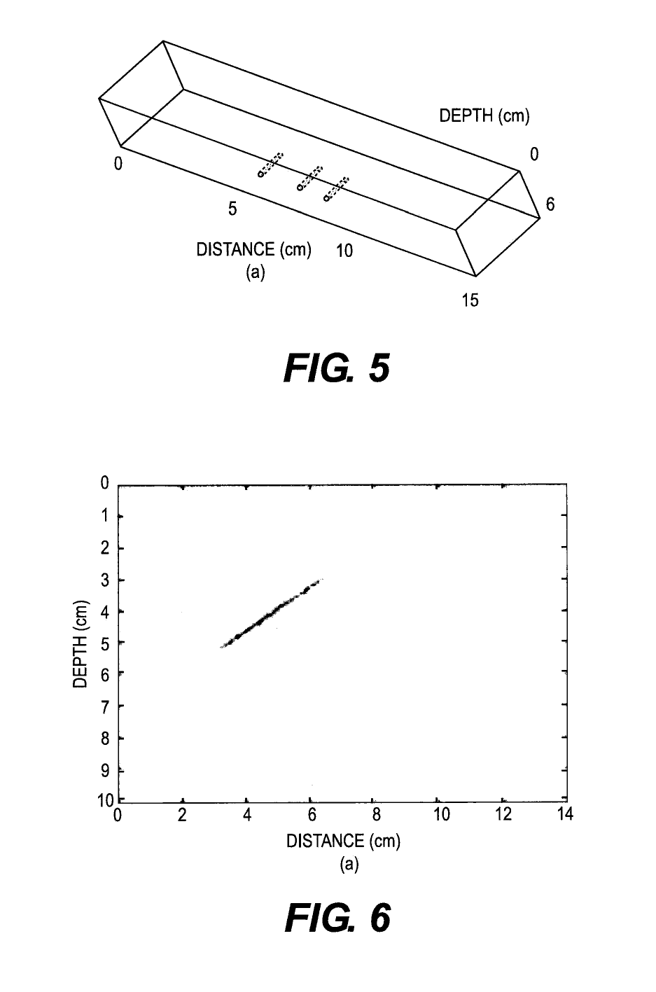

FIG. 5 illustrates an exemplary three-dimensional model of the tested rail based on the migrated ultrasound data mapped above in FIG. 4. As discussed above, processor 5 may compile the cross-sectional images of the migrated ultrasound data taken along the length of the tested rail. A three-dimensional model of the rail may be produced, and the size, location, and orientation of detected internal rail defects may be mapped within the volume of the three-dimensional rail model. As illustrated in FIG. 5, the three transverse holes may be accurately modeled and imaged relative to the internal structure of the three-dimensional rail model.

FIG. 6 illustrates another exemplary unmigrated intensity map. The intensity map of FIG. 6 may be, for example, a color map that maps intensity of backscattered ultrasound energy from an angled, planar fracture internal a tested rail. To detect angled and planar fractures and defects, ultrasonic shear waves (i.e., S-waves) may be emitted from probe 2 to detect the presence of the fracture. Probe 2 may be suitably angled by, for example, a wedge or other structure, such that the direction of the emitted shear waves may be substantially perpendicular to the angled fracture. This orientation may ensure that a suitable amount of ultrasound energy is reflected back and measured. It is also contemplated that a couplant, such as water, may be employed. The couplant may be between the probe and the rail, and may be used to generate refracted shear waves by mode conversion of longitudinal waves. Such a configuration may obviate the need for conventional probe wedges, as discussed above. The ultrasound array may be inclined in the couplant such that radiated energy impinges substantially perpendicular to the defect plane, thereby maximizing reflected energy. The unmigrated ultrasound data may identify the intensity of reflected energy from the angled fracture, but the actual location, size, and orientation of the fracture may not be accurately identified.

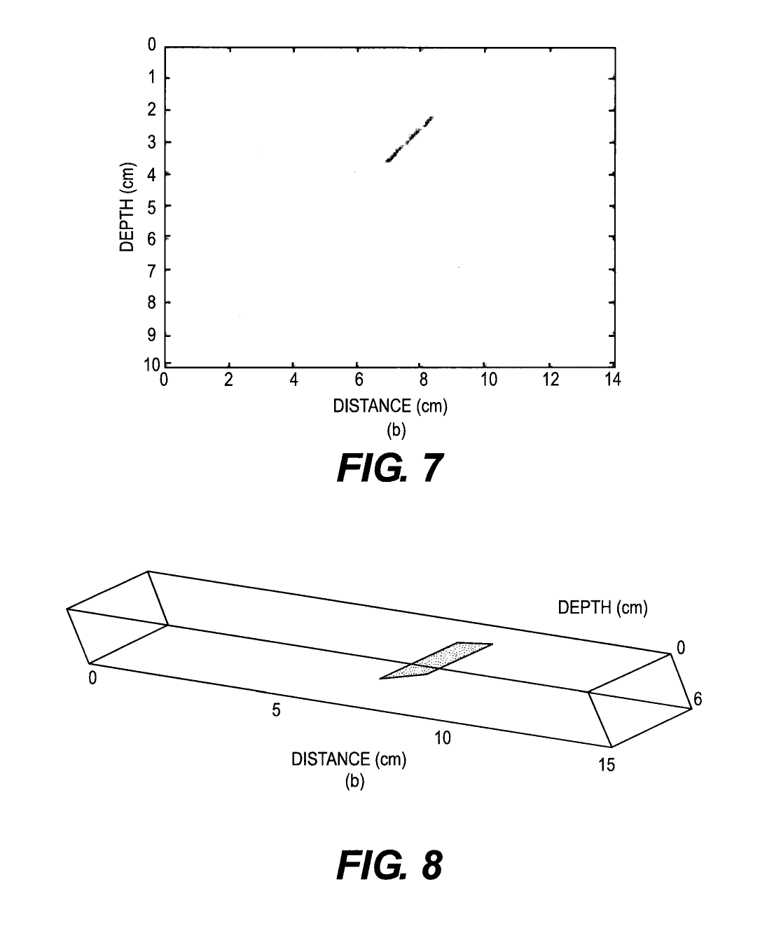

FIG. 7 illustrates an exemplary migrated intensity map. The intensity map of FIG. 7 may be, for example, another color map that maps intensity of backscattered ultrasound energy from the same angled fracture tested above in FIG. 6. As shown in FIG. 7, migrating the ultrasound data may correctly orient the angle of the tested fracture and correctly size and position the fracture relative to the rail.

FIG. 8 illustrates another exemplary three-dimensional model of the tested rail based on the migrated ultrasound data mapped above in FIG. 7. Processor 5 may compile the cross-sectional images of the migrated ultrasound data taken along the length of the tested rail. A three-dimensional model of the rail may be produced, and the size, location, and orientation of detected angled fracture may be mapped within the volume of the three-dimensional rail model. As illustrated in FIG. 8, the angled fracture may be accurately modeled and imaged relative to the internal structure of the three-dimensional rail model.

As alluded to above, it should also be appreciated that processor 5 may generate a three-dimensional image of the rail, in addition to the three-dimensional model. In other words, an actual image of the rail may be generated, with the internal defects accurately sized, positioned, and oriented within the volume of the rail image. The three-dimensional rail image may then be displayed on display 6.

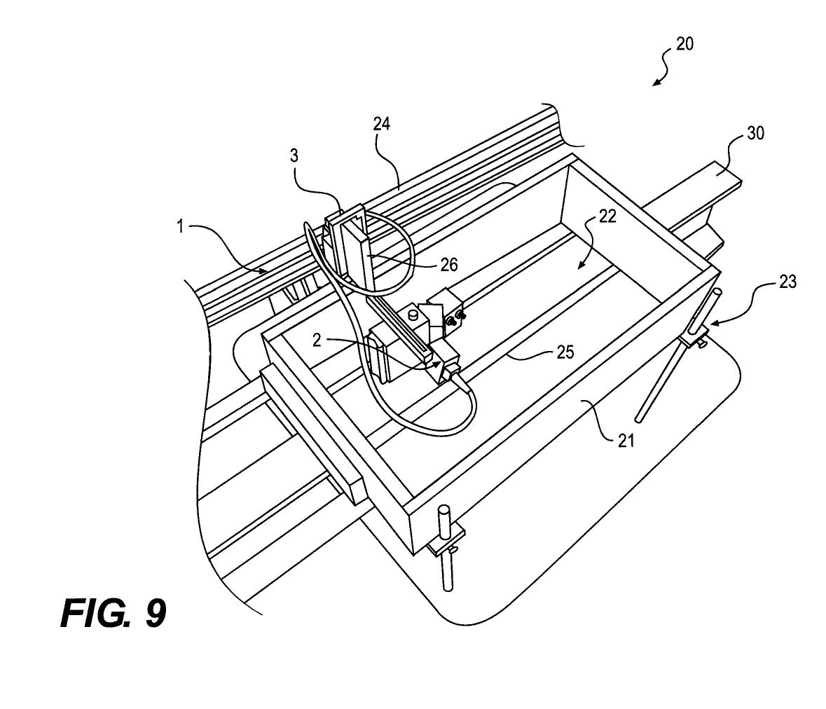

FIG. 9 illustrates a perspective view of an exemplary support mechanism 20 for ultrasonic rail inspection system 1. Support mechanism 20 may include a testing container 21, a sealing membrane 22, a plurality of support legs 23 coupled to testing container 21, and a linear track 24.

Testing container 21 may be a sealed structure, and may be configured to hold a suitable volume of an acoustic couplant, such as water or glycerin. For instance, testing container 21 may be an appropriately shaped box made of, as examples, a plastic, a polymeric material, or epoxy-coated wood. Testing container 21 may include a channel 25, wherein a testing area of a rail 30 may be disposed. Channel 25 may be an opening positioned on a bottom surface of testing container 21. The opening may be substantially rectangular in shape and may extend along an entire length of container 21 and through opposite end walls of container 21. In other words, the opening may act as a slot at the bottom surface of testing container 21 in which rail 30 may be positioned.

Sealing membrane 22 may be configured to conform to any shaped rail and may include any suitable elastic material, such as silicone rubber or the like. In addition, sealing membrane 22 may be configured to provide a sealed barrier between rail 30 and the acoustic couplant contained within testing container 21. Sealing membrane 22 may be disposed on top of rail 30 when rail 30 is positioned within channel 25. Sealing membrane 22 may substantially cover rail 30 and channel 25 and may also extend the entire length of testing container 21. Moreover, sealing membrane 22 may be suitably secured to the bottom surface of testing container 21 by, for example, appropriate fasteners, or alternatively, by applying tension to sealing membrane 22 to stretch and hold sealing membrane 22 against the bottom surface. Accordingly, the acoustic couplant may be sealed from leaking through channel 25 and from contacting rail 30.

It should also be appreciated that sealing membrane 22 may not adversely interfere with ultrasound testing. For example, probe 2 may directly contact sealing membrane 22 and may receive ultrasound data when testing rail 30. In other words, rail 30 may be acoustically exposed to probe 2 through sealing membrane 22. The material selection and thickness of sealing membrane 22 may provide the desired acoustic exposure of rail 30. For instance, sealing membrane 22 may be formed of a thin film of silicone rubber.

The plurality of support legs 23 may position testing container 21 at an appropriate height relative to rail 30 and may be adjusted accordingly. For example, support legs 23 may include one or more adjustable jacks coupled to testing container 21 and configured to raise and lower testing container 21.

Linear track 24 may include a suitable structure configured to guide probe 2 and encoder 3, and may allow encoder 3 to determine the linear position of probe 2 along rail 30. Linear track 24 may include, for example, rails or tracks, and encoder 3 may include wheels to move along the rails or tracks. The positions of encoder 3 along track 24 may be translated to corresponding positions on rail 30. A coupling member 26 may be configured to couple probe 2 to encoder 3. Accordingly, the position of probe 2 along rail 30 may be identified, recorded, and observed via encoder 3.

Support mechanism 20 may provide a portable station for testing rail portions with ultrasonic rail inspection system 1. Testing container 21 may be transported to a testing site, and may be merely placed over the rail portion such that the rail portion may be disposed within channel 25. Sealing membrane 22 may then be positioned over the rail portion and channel 25, and thus, testing container 21 may provide a stationary medium for an acoustic couplant.

Any aspect set forth in any embodiment may be used with any other embodiment set forth herein. Moreover, the features set forth herein may be used in any other ultrasonic testing setting, such as for non-destructive testing of metals, alloys, concrete, wood, and composites, and in any suitable industry, such as the metal production, aerospace, and automotive sectors.

The many features and advantages of the present disclosure are apparent from the detailed specification, and thus, it is intended by the appended claims to cover all such features and advantages of the present disclosure which fall within the true spirit and scope of the present disclosure. Further, since numerous modifications and variations will readily occur to those skilled in the art, it is not desired to limit the present disclosure to the exact construction and operation illustrated and described, and accordingly, all suitable modifications and equivalents may be resorted to, falling within the scope of the present disclosure.

What is claimed is:

1. A method for imaging internal flaws of a rail, the method comprising:
transmitting multiple ultrasound pulses into the rail along transverse and longitudinal axes of the rail;
acquiring reflected ultrasound data from the rail;
processing the reflected ultrasound data by applying an ultrasound migration technique to the reflected ultrasound data; and
mapping the internal flaws of the rail based on the reflected ultrasound data processed by the ultrasound migration technique.

2. The method of claim 1, wherein mapping the internal flaws of the rail includes producing cross-sectional images of the rail including the internal flaws.

3. The method of claim 2, further comprising compiling the cross-sectional images of the rail along the rail and producing a three-dimensional model of the rail based on the compiled cross-sectional images.

4. The method of claim 3, further comprising mapping the internal flaws relative to the three-dimensional model of the rail.

5. The method of claim 4, further comprising positioning one or more representations of the internal flaws within a volume of the three-dimensional model of the rail.

6. The method of claim 5, further comprising displaying the three-dimensional model of the rail on a display.

7. A method for imaging internal flaws of a rail, the method comprising:
transmitting multiple ultrasound pulses into the rail along a plurality of axes of the rail;
acquiring reflected ultrasound data from the rail;
processing the reflected ultrasound data by applying an ultrasound migration technique to the reflected ultrasound data;
compiling cross-sectional images of the internal flaws of the rail along the rail based on the reflected ultrasound data processed by the ultrasound migration technique; and
producing a three-dimensional model of the rail based on the compiled cross-sectional images, wherein the internal flaws of the rail are mapped within the three-dimensional model of the rail.

8. The method of claim 7, further comprising transmitting multiple ultrasound pulses into the rail along transverse and longitudinal axes of the rail.

9. The method of claim 7, wherein applying an ultrasound migration technique includes implementing a Kirchhoff migration algorithm by a processor.

10. The method of claim 7, further comprising classifying the internal flaws of the rail based on at least one of a size and a position of the internal flaws relative to the rail.

11. The method of claim 7, further comprising displaying the three-dimensional model of the rail on a display.

12. The method of claim 7, further comprising advancing a multiple element array probe along a length of the rail, wherein the multiple element array probe is configured to transmit the multiple ultrasound pulses into the rail.

13. The method of claim 12, wherein the multiple element array probe is configured to acquire the reflected ultrasound data from the rail as the multiple element array probe is advanced along the length of the rail.

14. A method for imaging an internal flaw of a rail, the method comprising:
transmitting multiple ultrasound pulses into the rail along a plurality of axes of the rail;
acquiring reflected ultrasound data from the rail;
processing the reflected ultrasound data by applying an ultrasound migration technique to the reflected ultrasound data;
determining a size of the internal flaw relative to the rail based on the reflected ultrasound data processed by the ultrasound migration technique;
determining a position of the internal flaw relative to the rail based on the reflected ultrasound data processed by the ultrasound migration technique; and
classifying the internal flaw under one or more types of rail defects.

15. The method of claim 14, further comprising determining an orientation of the internal flaw relative to the rail based on the reflected ultrasound data processed by the ultrasound migration technique.

16. The method of claim 15, further comprising compiling cross-sectional images of the internal flaw of the rail based on the reflected ultrasound data processed by the ultrasound migration technique.

17. The method of claim 16, further comprising producing a three-dimensional model of the rail based on the compiled cross-sectional images.

18. The method of claim 17, further comprising producing a representation of the internal flaw within a volume of the three-dimensional model of the rail based on at least one of the size and the position of the internal flaw.

19. The method of claim 14, wherein the one or more types of rail defects includes a transverse fracture, a detail fracture, and a vertical split head.

20. A support mechanism for an ultrasonic rail inspection system including a probe and an encoder, the support mechanism comprising:
a container for holding an acoustic couplant, the container including a channel for receiving a rail;
a sealing membrane configured to provide a barrier between the rail and the acoustic couplant contained within the container;
a track configured to allow the probe to translate along the rail; and
a coupling device configured to couple the probe to the encoder.
